(19) United States
(12) Patent Application Publication
(10) Pub. No.: US 2013/0180463 A1
(43) Pub. Date: Jul. 18, 2013

(54) COLLAPSIBLE ANIMAL SHELTER FOR USE AS AN ANIMAL BED

(71) Applicant: Barry Messner, Anaheim Hills, CA (US)

(72) Inventor: Barry Messner, Anaheim Hills, CA (US)

(73) Assignee: MS Ventures, LLC, Foothill Ranch, CA (US)

(21) Appl. No.: 13/385,602

(22) Filed: Dec. 2, 2011

(51) Int. Cl. A01K 1/035; A01K 1/03

(52) U.S. Cl. CPC A01K 1/0353; A01K 1/033
USPC 119/498; 119/28.5

(57) ABSTRACT

The present invention relates to a collapsible or foldable structure suitable for a variety of applications, such as animal bed, animal shelter or animal carrier. The structure in its collapsed state forms an animal bed and when fully erect forms an animal shelter or carrier. The structure comprises a first layer and a second layer that are fused together by a seam or a crease. When in the collapsed stated, the second layer forms the base of the pet bed and the first layer is collapsed against the second layer to form a pet bed. The first layer is comprised of flexible or semi-flexible material that can be lifted upward and separated from the second layer to form the roof and sides of an animal shelter or carrier when fully erect. The first layer may include seams or creases for ease of conversion and structural stability. The first and second layers may be formed from semi-flexible foam covered with fabric. Optionally, the first and second layers may be made of materials that have insulating or waterproof qualities. Additionally, the structure may include a pillow for being positioned on top of the second layer when the structure is in the erect state and on top of the first layer when the structure is in its collapsed state, acting as a pet bed.

### BACKGROUND OF THE INVENTION

1. Field of the Invention.

The present invention relates to an animal shelter and animal bed, and, in particular, an animal shelter that collapses to form an animal bed.

2. Related Art.

Animal beds and animal shelters, commonly referred to as pet beds and pet shelters, are well known. Pet beds are provided to allow one's pet to have a comfortable place to rest, and are especially usually for pets that are not allowed to sleep on beds or couches. Pet beds are typically designed to be generally flat, fabric covered cushions that come in many shapes and sizes.

In addition to pet beds, some animals prefer to sleep or take shelter in enclosed areas. Such enclosures take the form of crates, houses or carriers. The shelters are generally constructed to have a top, bottom, sides and front opening with or without a door. Such shelters may be used for the sole purpose of shelter or may be utilized as transportation carriers, in which case, the shelters usually include doors that are maintained in a closed position by a locking mechanism accessible only from the outside of the carrier. Shelters are generally made of metal, plastic, wood or fabric, or a combination of any of the materials. When in use, the shelters generally take up a significant amount of space, especially those designed for use by larger animals. Many shelters are designed to be disassembled, collapse or fold to minimize the size of the shelters for storage and transportation purposes. Rather than store the shelters when not in use, it would be useful if shelters were provided that, in their collapsed state, could function as another useful article for use by a pet.

A need therefore exists for a shelter that, it its collapsed state, functions as a pet bed. A further need exists for a shelter that is comprised of a soft pliable material that when in a collapsed state forms a cushion for a pet. Yet a further need exists for the shelter that collapse into a pet bed and that includes an additional cushion for use with the shelter and the pet bed.

### SUMMARY

Accordingly, a collapsible shelter is provided that, when in its closed or collapsed state, forms a pet bed. While the invention may be characterized as a collapsible shelter, it may also be characterized as a convertible pet bed that is expandable into a pet shelter.

The structure of the present invention comprises a first layer and a second layer that are fused together by a seam or a crease. When in the collapsed stated, the second layer forms the base of the pet bed and the first layer is collapsed against the second layer to form a pet bed. The first layer is comprised of flexible or semi-flexible material that can be lifted upward and separated from the second layer to form the roof and sides of an animal shelter or carrier when fully erect. The first layer may include seams or creases for ease of conversion and structural stability. The first and second layers may be formed from semi-flexible foam covered with fabric. Optionally, the first and second layers may be made of materials that have insulating or waterproof qualities. Additionally, the structure may include a pillow for being positioned on top of the second layer when the structure is in the erect state and on top of the first layer when the structure is in its collapsed state, acting as a pet bed.

As described above, the structure may be characterized as animal bed, with an optional removable pillow or cushion, which erects into an animal shelter or carrier, or an animal shelter having a roof and sides that collapse into the base to form an animal bed. The top and sides of the shelter may have seams or creases that are positioned in such manner that the roof and part of the sides can be more easily collapsed into the bottom platform to form an animal bed. In a fully erect state, when the structure forms an animal shelter or carrier, the front has an opening for ingress and egress of an animal. When upward force is applies to the top part or roof of the structure, it is inverted upwards to form the sides and roof of the animal shelter or carrier. When downward force is applied to the top part or roof of the animal bed, the roof and sides invert downward to conform to the base of the shelter and create an animal bed. The removable pillow or cushion may be positioned on the area of the pet bed or shelter on which the animal will rest, which is either on top of the roof structure when in the collapsed stated form the animal bed or the inside the structure on base when the structure is erect to form an animal shelter.

The structure can be constructed from various materials, such as foam, fabric, plastic or similar material capable of being reconfigurable. The materials may further include thermal insulating properties or properties that protect the surroundings from moisture and dirt. In additional to acting as a pet bed, the structure, when collapsed, provides a compact structure for ease of storage or transport. The invention relates to foldable/portable animal shelters or carriers that can be collapsed into a configuration that takes up much less space and can therefore be easily stored or transported.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a front view of the structure in a fully collapsed state forming an animal bed with optional removable pillow or cushion.

FIG. 2 shows the optional pillow or cushion removed from the structure in a fully collapsed state forming an animal bed.

FIG. 3 is a front end view of the structure in a partially erected state, which shows the animal bed being converted into an animal shelter or carrier via the up force arrow.

FIG. 4 shows the structure in a fully erect state forming an animal shelter or carrier with the optional pillow or cushion being placed inside on top of the bottom part of the structure.

### DETAILED DESCRIPTION

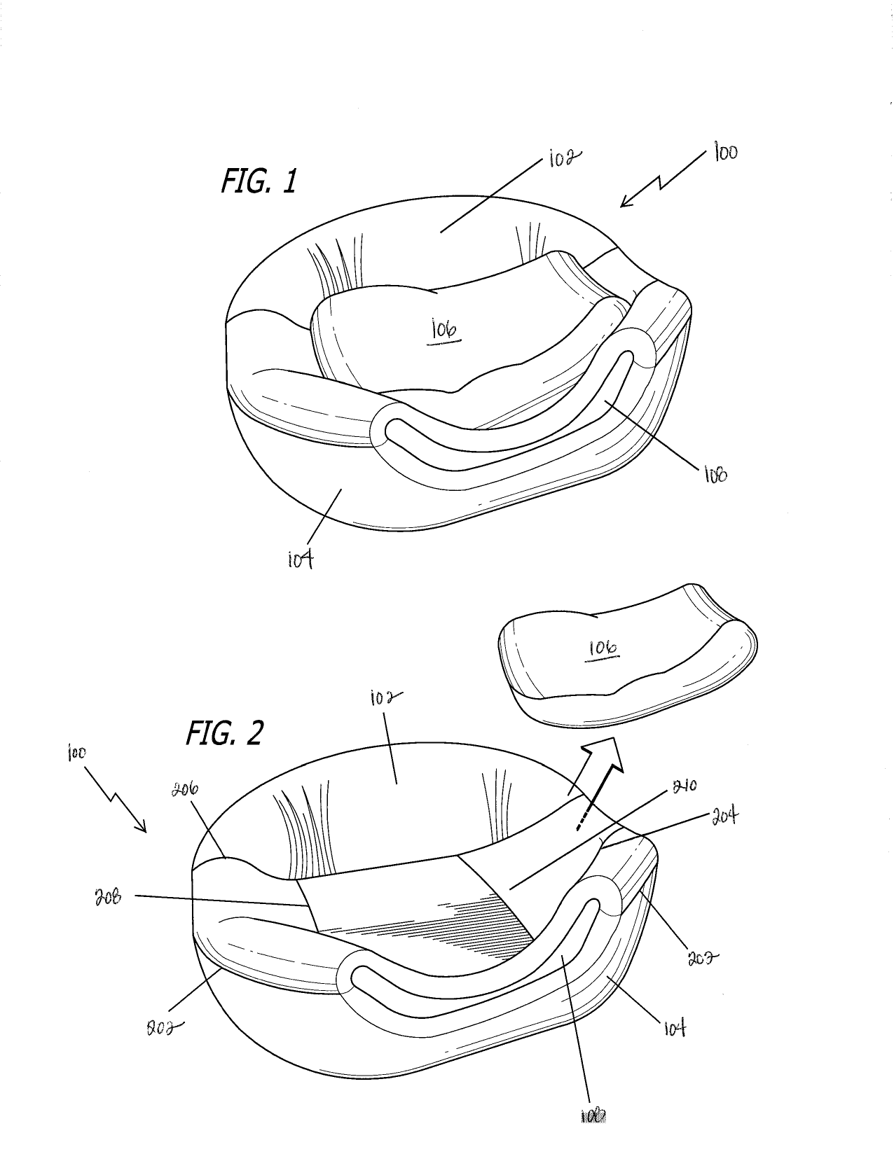

FIGS. 1-4 illustrate one example of an implementation of the present invention. In particular, FIG. 1 illustrates a front view of the structure 100 in a fully collapsed state forming an animal bed with optional removable pillow or cushion 106. As illustrated, the optional removable pillow or cushion at 106 may rest on top of the structure in its collapsed or closed state. The top part or first layer of the structure 102 can be made of any flexible material capable of reconfiguring from a collapsed or closed state to an erect or open state. In the collapsed state, the first layer 102 forms the top layer of the animal bed 100. The second layer or bottom part of the structure 104 forms the bottom part of the pet bed when the structure is in its collapsed form. A cut is provided in either or both the first and second layers 102, 104 on one side of the structure to form an opening 108 in the structure when in the erect state. The opening 108 forms the ingress or egress to the animal shelter or carrier when the structure 100 is in its erect state.

FIG. 2 illustrates the collapsible or foldable structure at 100, with the structure in a collapsed state, with the optional pillow or cushion at 106 being removed. In the illustrated example, the bottom part 104 of the structure 100 is connected to the top part 102 of the structure by a seam or crease 202. The edge of the opening 108 forms the end points for the seam or crease at 202, which fuses the top and bottom part of the structure together. The top part 102 contains two seams or creases 204 and 206, approximately parallel to the opening 108 and which together with the seam or crease 202 divides the top part into sections. The two seams or creases at 204 and 206 ends at the seam or crease at 202 on opposite sides of the structure. The middle section of the top part 104, between the seams or creases 204 and 206, contains two seams or creases 208 and 210 in approximately a ninety degree angle to the seams or creases at 204 and 206. The ending point of the seams or creases 208 and 210 is the seams or creases 204 and 206. The seams or creases at 204, 206, 208 and 210 divide the top part at 104 into five sections, which permit the top part 102 to collapse into the base 104 of the structure 100 to conform to the base 104.

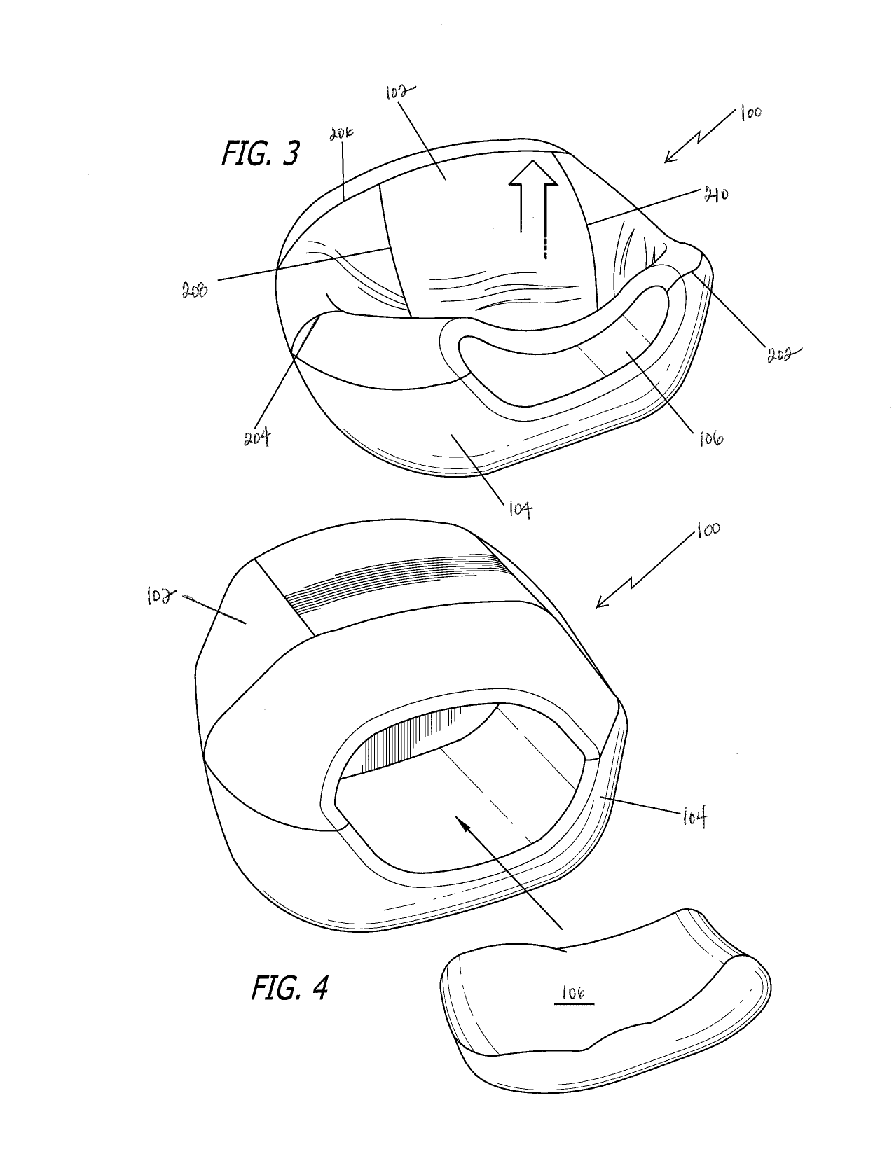

FIG. 3 illustrates the collapsible or foldable structure 100 in a partially erect state. The top part 102 of the structure 100 is inverted upward, by applying pressure to the underside of the top part 102 of the structure 100. As pressure is exerted upward, the top part 102 inverts into a dome shape, forming the roof and sides of the animal shelter or carrier. The seams or creases 204, 206, 208, 210 in the construction of the top part 102 allow the flexible material of the top part 102 to form the roof and sides of the animal shelter or carrier 100.

FIG. 4 illustrates the collapsible or foldable structure 100 in a fully erect state. The bottom part 104 forms the bottom or base of the shelter 100 and a portion of the sides of the animal shelter or carrier 100. The top part 102 forms the roof and top part of the sides of the animal shelter or carrier. The optional pillow or cushion 106 can be inserted into the fully erected animal shelter or carrier and placed on top of the bottom part 104 to provide added comfort or insulation. When the top part 102 is erect, the opening 108 forms a fully opened ingress and egress to the animal shelter or carrier, and a hollow chamber is formed between the top part 102 and bottom part 104 to form a shelter 100.

The structure can be constructed from various materials, such as foam, fabric, plastic or similar material capable of being reconfigurable. The materials may further include thermal insulating properties or properties that protect the surroundings from moisture and dirt. Those skilled in the art will recognize that it is not necessary for the bottom part to be constructed of material capable of being reconfigured, as the bottom part remains fixed in the illustrated example. As such, the bottom part may optionally be made of a ridge material.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. An animal bed, the animal bed comprising:
a first layer; and
a second layer, where the first layer is positioned against the second layer in a closed stated and where the second layer is moveable from the closed state to an open state to create a hollow chamber between the first layer and second layer to form a pet shelter.

2. A collapsible or foldable structure forming an animal bed in its collapsed state that can be converted into an animal shelter or carrier when erected, the structure comprising:
a top part and a bottom part that are fused together by a seam or crease;
the bottom part forming the base of the structure;
the top part being mad of a flexible material that can alternate between a collapsed and erect state to form the first layer of an animal bed or the roof and partial sides of an animal shelter; and
where a cut-out is provided between the top and bottom part along a portion of the seam or crease fusing the top part and bottom part together to create an opening for egress and ingress of an animal into the shelter when the top part is in its erect state.
